(19) United States
(12) Patent Application Publication
(10) Pub. No.: US 2001/0051896 A1
(43) Pub. Date: Dec. 13, 2001

(54) System for electronic mail enclosing gift coupon and transmitting method thereof

(76) Inventors: Jung-Kee Noh, Seoul (KR); Jung-Hee Choi, Seoul (KR); Sae-Young Yoon, Seoul (KR)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 09/752,953

(22) Filed: Jan. 2, 2001

(30) Foreign Application Priority Data
Jan. 5, 2000 (KR) 2000-353
May 26, 2000 (KR) 2000-28612

(51) Int. Cl. G06F 17/60; G06F 15/16

(52) U.S. Cl. 705/14; 709/206

(57) ABSTRACT

The present invention relates to a system for an electronic mail enclosing a gift coupon and its transmitting method. A sender who intends to send an e-mail is connected to a Web server that offers an e-mail service and writes an e-mail message. A sender who has written an e-mail message transmits the message enclosing a gift coupon given a lottery number to a recipient. The recipient checks the e-mail and accepts receipt of the gift coupon. Related information of the recipient who accepts receipt of the gift coupon is stored in a database of a gift coupon providing server. The gift coupon providing server informs the recipient as to whether he or she has won a gift. According to the system for an electronic mail enclosing a gift coupon and its transmitting method of the present invention, an advertisement content can be effectively transmitted to the Internet users, for which the Internet users can favorably and voluntarily click on the banner advertisement so that they can receive the advertisement content as well as various Internet services. In so doing, a maximized advertisement effect can be made for the advertisers at the same time.

### BACKGROUND OF THE INVENTION

1. Field of the Invention

The present invention relates to a system for an electronic mail (e-mail) enclosing a gift coupon and its transmitting method, and more particularly to a system for an e-mail enclosing a gift coupon with a lottery number for winning a gift. The gift coupon lottery number is enclosed in an e-mail and transmitted to a recipient, so that the e-mail recipient may have a chance to register the gift coupon after seeing an on-line advertisement.

2. Description of the Related Art

Recently, service businesses on the Internet have drawn much attention due to the explosively increasing number of the Internet users. An e-mail service is one of the primary services provided by the Internet, and besides the e-mail service, information providing and advertisement businesses have rapidly expanded its size as a field of lucrative business.

In case of the Internet advertisement business, one of a profitable businesses through the Internet, banner advertisement is typically used to display an advertisement content in a rectangular image file (i.e., a GIF image) having a size of 1˜2 centimeters long by 4˜6 centimeters wide.

The banner advertisement is an advertising technique in which one or more banners are displayed on a page of a portal or a specific Web site to which Internet users are connected, expecting that the so-called ‘netizens’ click on them to visit a Web site of a linked advertiser.

However, in case of the banner advertisement according to the conventional art, its approaching method is so passive as to attract Internet user's interest, for which, statistically, less than one of hundred netizens would click on the banner advertisements, failing to meet advertisers' expectations.

Meanwhile, in case of some advertisements-only sites, they adopt a method that advertisement fee paid by advertisers is partially distributed to the Internet users whenever they click on banner advertisements in a form of cyber money. But it also does not attract the Internet users because it is difficult to directly withdraw the reserved cyber money as a type of cash, and simply clicking on the banner advertisements is not enough to attract the Internet users' interest, which is also far from satisfying the advertisers' expectations in view of its advertising impact.

### SUMMARY OF THE INVENTION

Therefore, an object of the present invention is to provide a system for an electronic mail enclosing a gift coupon and its transmitting method, which is capable of effectively conveying an advertisement content to Internet users on the Internet.

Another object of the present invention is to provide a system for an electronic mail enclosing a gift coupon which is capable of inducing Internet users to voluntarily click on banner advertisement so that the Internet users are provided with the advertisement content as well as the Internet service, and its transmitting method.

Still another object of the present invention is to provide a system for an electronic mail enclosing a gift coupon which is capable of offering Internet users a chance to win a gift as well as bring a maximized advertisement impact to advertisers, and its transmitting method.

To achieve these and other advantages in accordance with the purpose of the present invention, as embodied and broadly described herein, there is provided an electronic mail transmitting method in which an information providing server provides users with information through an electronic mail on the Internet, comprising the steps of: transmitting an electronic mail containing information with a gift coupon given a lottery number from the information providing server to the user; checking the electronic mail and accepting receipt of the gift coupon on a user's terminal; storing the information of the user who has accepted receipt of the gift coupon in a database of a gift coupon providing server; and informing the user of whether he or she has won a gift.

To achieve the above objects, there is also provided an electronic mail transmitting method comprising: connecting with a Web server which offers an e-mail service and writing an e-mail message; transmitting the e-mail enclosing a gift coupon given a lottery number from a sender who has written the e-mail message to a recipient; checking the e-mail and accepting receipt of the gift coupon on a recipient's terminal; storing information of the recipient who accepted receipt of the gift coupon in a database of a gift coupon providing server; and informing the recipient of whether he or she has won a gift.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a schematic view showing construction of a system for a gift coupon-enclosed electronic mail in accordance with a first embodiment of the present invention;

FIG. 1B is a flow chart of processes of a method for transmitting a gift coupon-enclosed electronic mail in accordance with the first embodiment of the present invention;

FIG. 1C is a flow chart of processes of a method for transmitting a gift coupon-enclosed electronic mail in accordance with a modification of the first embodiment of the present invention;

FIG. 2A is a schematic view showing construction of a system for gift coupon-enclosed electronic mail in accordance with a second embodiment of the present invention;

FIG. 2B is a flow chart of processes of a method for transmitting a gift coupon-enclosed electronic mail in accordance with the second embodiment of the present invention;

FIG. 2C is a flow chart of processes of a method for transmitting a gift coupon-enclosed electronic mail in accordance with a first modification of the second embodiment of the present invention;

FIG. 3A through 3H are exemplary views showing the processes of a method for transmitting a gift coupon-enclosed electronic mail displayed on a Web browser of a user in accordance with a second modification of the second embodiment of the present invention;

FIG. 4 is a flow chart of processes of a method for transmitting a gift coupon-enclosed electronic mail in accordance with a third embodiment of the present invention; and

FIG. 5 is a flow chart of processes of a method for transmitting a gift coupon-enclosed electronic mail in accordance with a modification of the third embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

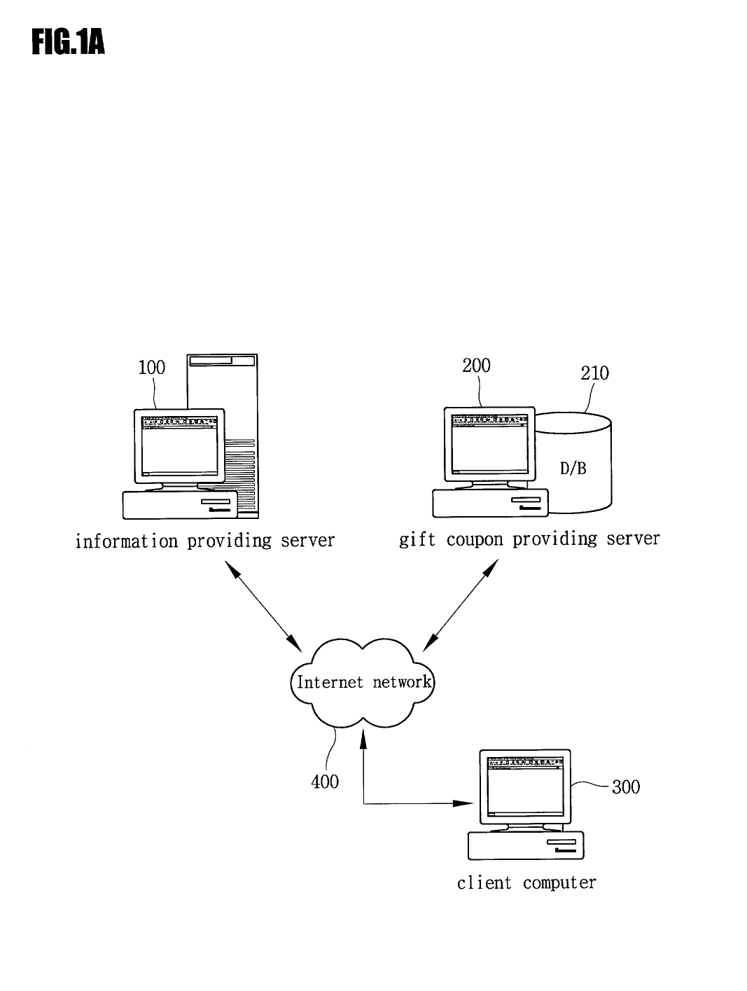

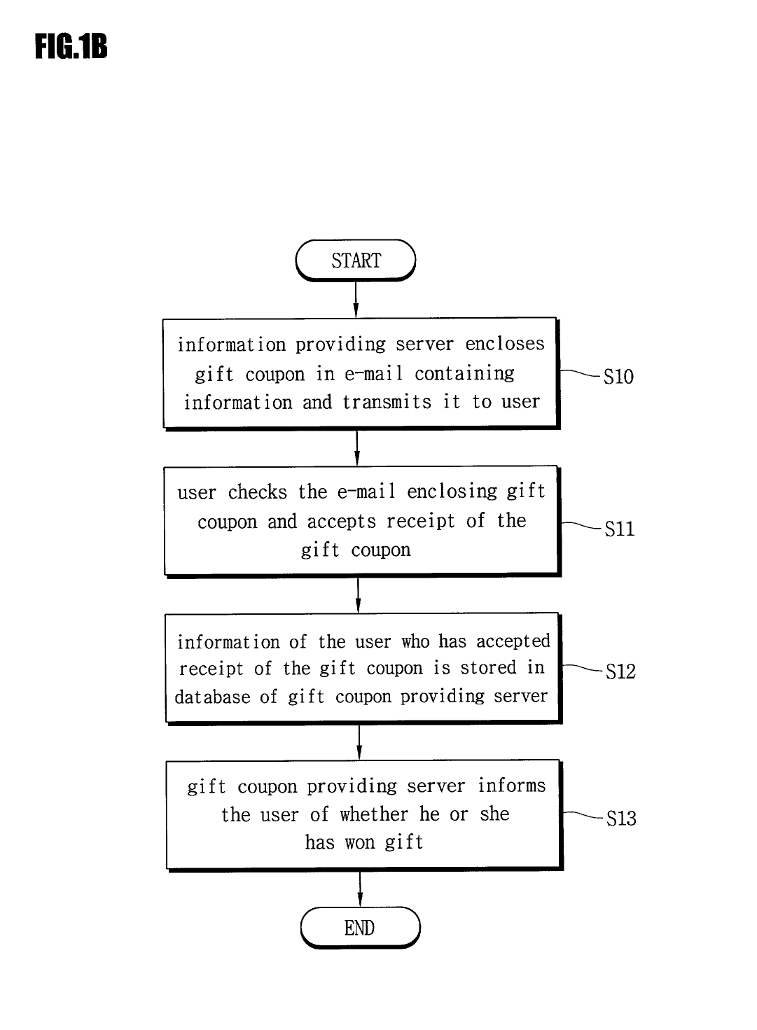

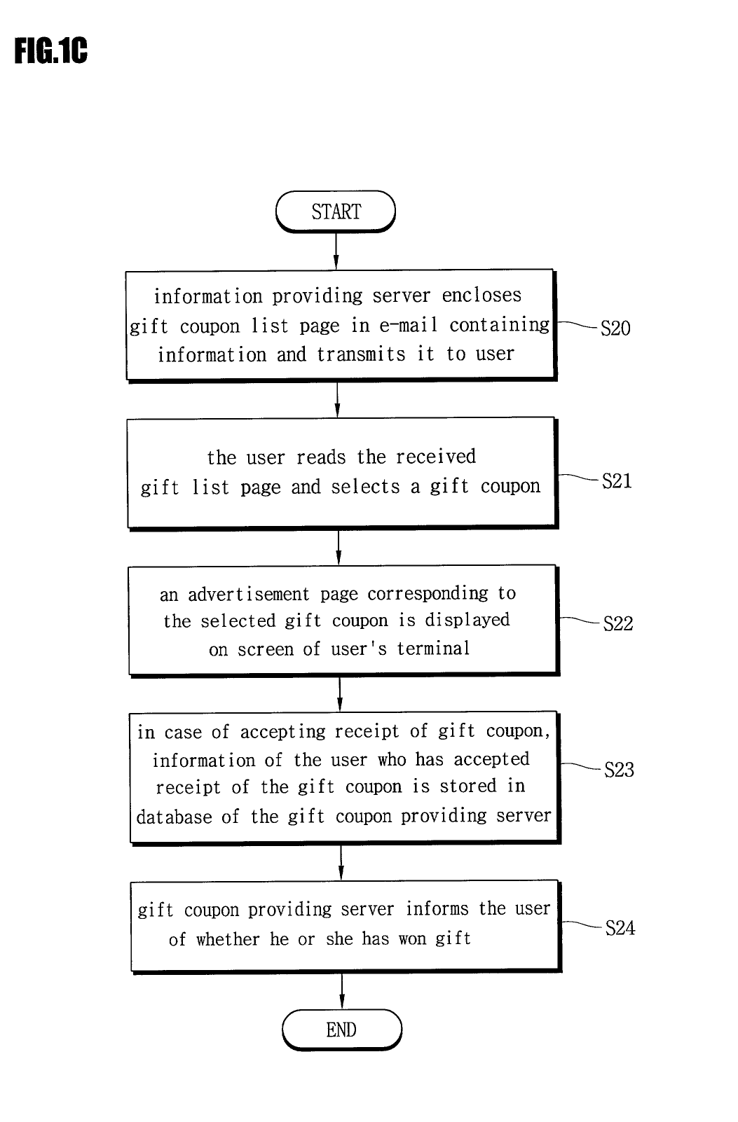

FIG. 1A is a schematic view showing construction of a system for a gift coupon-enclosed electronic mail in accordance with a first embodiment of the present invention.

Referring to FIG. 1A, an information providing server 100 for providing various types of information such as news, stock information and child-caring information, etc., a gift-coupon providing server 200, and a client computer 300 are connected to each other through the Internet 400.

The system for a gift-coupon enclosed electronic mail in accordance with the first embodiment of the present invention is featured in that a gift coupon is automatically transmitted to the client by using the gift-coupon providing server 200 when the information providing server 100 provides specific information to the client 300 via an e-mail.

FIG. 1B is a flow chart of processes of a method for transmitting a gift coupon-enclosed electronic mail in accordance with the first embodiment of the present invention.

Referring to FIG. 1B, the information providing server 100 transmits an e-mail containing information plus a gift coupon given a lottery number to a user (S10). Then, the user receiving the information from the information providing server 100 checks the e-mail enclosing the gift coupon as received and accepts receipt of the gift coupon (S11).

When the user accepts receipt of the gift coupon, personal information of the user and the lottery number are stored in a database 210 of the gift coupon providing server 200 (S12). Also, preferably, an advertisement page linked to the gift coupon may be displayed on a screen of a terminal of the user.

Subsequently, in case that the gift coupon is one to be instantly confirmed for winning the gift, the gift-coupon providing server 200 informs immediately the user of his or her winning the gift with respect to the gift coupon (S13).

If the user win the gift, a form inquiring on the address of the winner or the like may be outputted to the screen of the terminal of the user, so as to receive information required for delivering the gift from the user.

Meanwhile, in case that the gift coupon is one which is not confirmed instantly, a message for confirmation of receipt of the gift coupon may be outputted on the screen and its related screen may be closed.

Preferably, the user may receive the e-mail message having information provided from the information providing server 100 as being contained in an advertisement page. In this case, the recipient just clicks on the gift coupon menu included in the advertisement page to thereby accept receipt of the gift coupon.

In this case, the advertisement page may include an e-mail message region, a button for selecting purchase of a corresponding product on the advertisement, an URL link region of an advertiser or a menu region for gift coupon receipt acceptance.

Upon reading the advertisement page, when the user determines purchase of a corresponding product and clicks on the button for selecting purchase of a corresponding product, a document consisting of a window for inputting a method for payment for a product for an instant order and a window for inputting a recipient address may be provided to the user.

FIG. 1C is a flow chart of processes of a method for transmitting a gift coupon-enclosed electronic mail in accordance with a modification of the first embodiment of the present invention.

The modification is different to the first embodiment of the present invention in the aspect that, when the information providing server 100 provides the client 300 with specific information via e-mail, it encloses a gift coupon list page therein so that the user who receives the e-mail may directly select his or her desired gift coupon to receive.

Referring to FIG. 1C, the information providing server 100 transmits an e-mail containing information and enclosing a gift coupon list page, to the user (S20). Upon receipt of the e-mail, the user reads the gift list page and selects one of the gift coupons (S21).

The gift coupon list page may take advantage of a page in which a plurality of banner advertisements are arranged, and in case that each banner advertisement is clicked, a CGI program or a Java program of a corresponding server as linked is executed. As the CGI program or the Java program are executed, an advertisement page corresponding to the selected gift coupon is linked and displayed on the screen of the terminal of the user (S22).

Then, the user may select whether he or she would receive the gift coupon or not by clicking on the button at the lower portion of the advertisement page.

In case that the user 300 who has received the e-mail accepts receipt of the gift coupon, the personal information of the user is stored in the database 210 of the gift coupon providing server 200 (S23).

Subsequently, the gift coupon providing server 200 may inform the user of a gift coupon winning date or whether he or she has won a gift (S24).

Preferably, in case that the user rejects to receive a gift coupon, a message indicating that the user has rejected receipt of a gift coupon may be displayed on the screen of the terminal of the user and then its related window is closed.

The first embodiment described above is featured in that the information providing server (that is, a business provider) transmits the gift coupon to the user by enclosing it in an e-mail.

Unlike the first embodiment, a second embodiment of the present invention relates to transmission of a gift coupon by being enclosed in an e-mail between users when they send e-mail to each other.

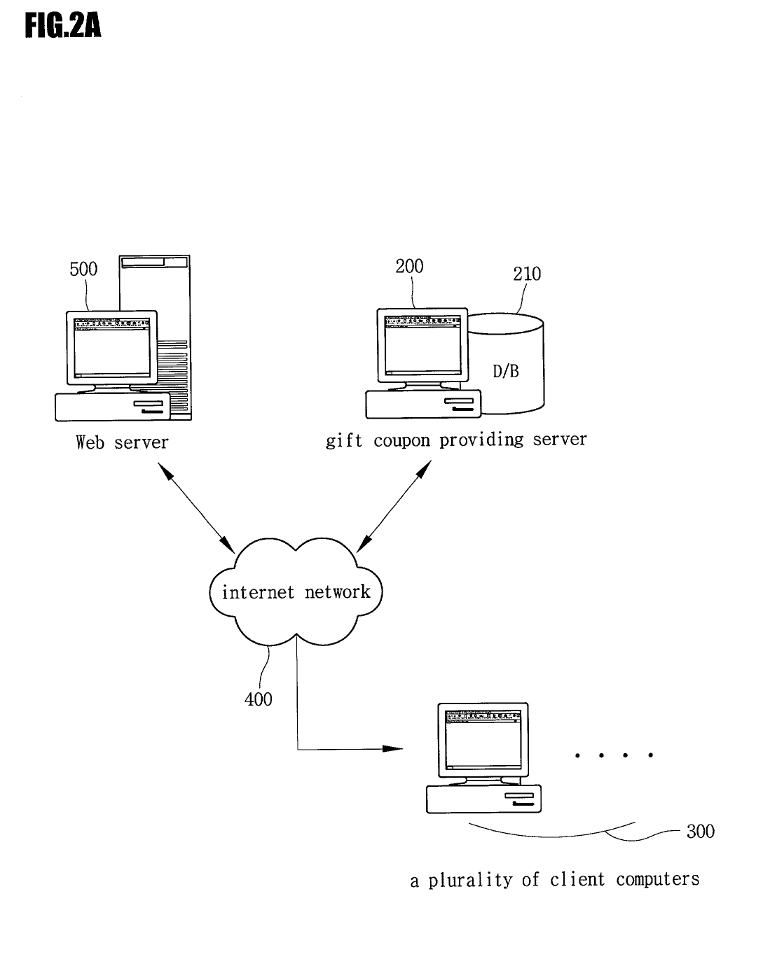

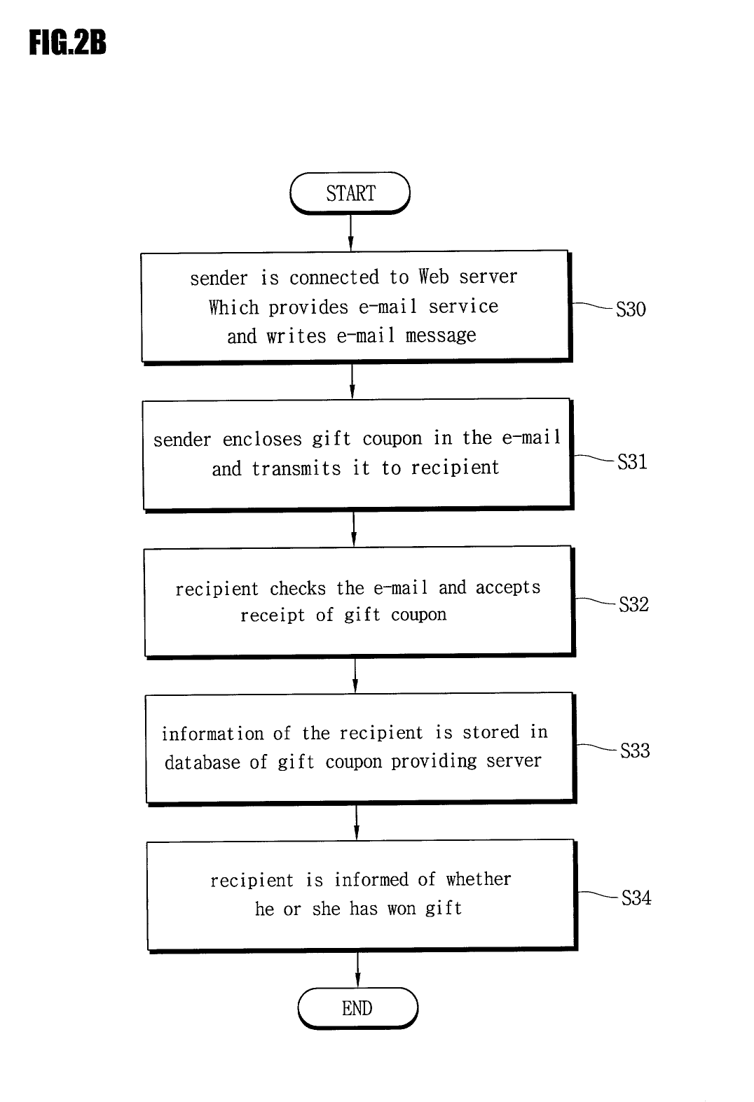

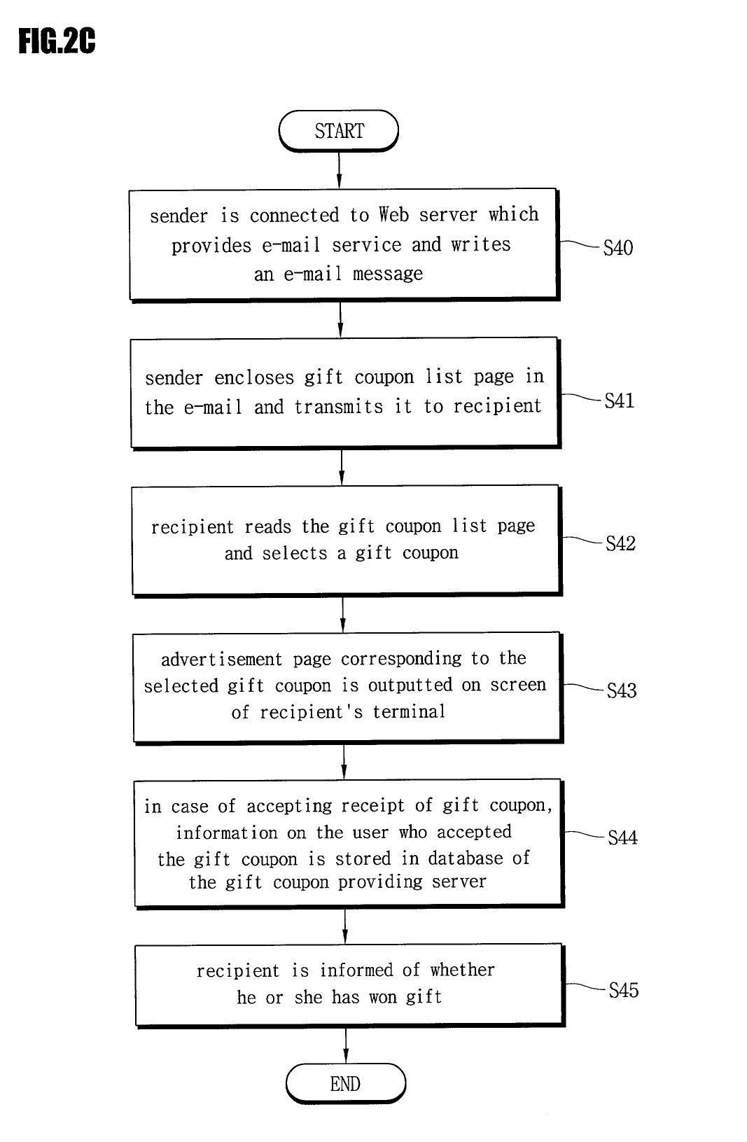

FIG. 2A is a schematic view showing construction of a system for a gift coupon-enclosed electronic mail in accordance with a second embodiment of the present invention.

Referring to FIG. 2A, a Web server 500 for offering an e-mail service, a gift-coupon providing server 200, and a plurality of client computers 300 for transmitting and receiving e-mail are connected to each other through the Internet 400.

The client computer 300 may be a Web phone, a cellular phone, a personal digital assistant (PDA) or a personal communication system (PCS) device as well as a desktop computer.

Also, the gift coupon-enclosed e-mail system of the present invention may be adopted to a voice message system (VMS) and a unified message system (UMS) in which communication messages, such as a voice message, a text message, an e-mail, a general phone, a picture and a facsimile message, are unified to be processed.

FIG. 2B is a flow chart of processes of a method for transmitting a gift coupon-enclosed electronic mail in accordance with the second embodiment of the present invention.

Referring to FIG. 2B, the user is connected to the Web server 500 which offers an e-mail service and writes an e-mail message (S30).

In this embodiment, the Web server 500 can provide the user with an e-mail service in a Web mail form, and may transmit an e-mail enclosing a gift coupon according to the user's selection (S31).

Subsequently, the recipient receives the e-mail and may accept receipt of the gift coupon (S32). At this time, preferably, the advertisement page linked to the gift coupon is displayed on the screen of the terminal of the user.

When the recipient accepts receipt of the gift coupon after he receives the e-mail, the personal information of the recipient is stored in the database 210 of the gift coupon providing server 200 (S33). The gift coupon providing server 200 may inform the user of his or her winning of the gift, instantly or after a predetermined time elapses (S34).

Preferably, the gift coupon proving server 200 informs the user of the gift winning date in advance prior to the step 34, and at this time, an advertisement may be also transmitted.

FIG. 2C is a flow chart of processes of a method for transmitting a gift coupon-enclosed electronic mail in accordance with a first modification of the second embodiment of the present invention.

Unlike the second embodiment, this modification is featured in that when an e-mail is transmitted, a gift coupon list page is enclosed therein so that, upon receipt of the e-mail, the recipient can directly select his or her desired gift coupon to receive.

Referring to FIG. 2C, the user is connected to the Web server 500 which offers an e-mail service and writes an e-mail message (S40).

Next, the user encloses a gift coupon list page containing a plurality of gift banner advertisements, each having a lottery number, in the e-mail as written and transmits it to a recipient (S41).

And then, the recipient reads the gift coupon list page and selects his or her desired gift coupon (S42).

Then, an advertisement page corresponding to the gift coupon selected according to the user's desire is displayed on the screen of the terminal of the user (S43).

At this time, when the recipient accepts receipt of the selected gift coupon, a personal information of the recipient is stored in the database 210 of the gift coupon providing server 200 (S44). The gift coupon providing server 200 may inform the recipient of the drawing date, or of his or her winning of the gift instantly or after a predetermined time elapses (S45).

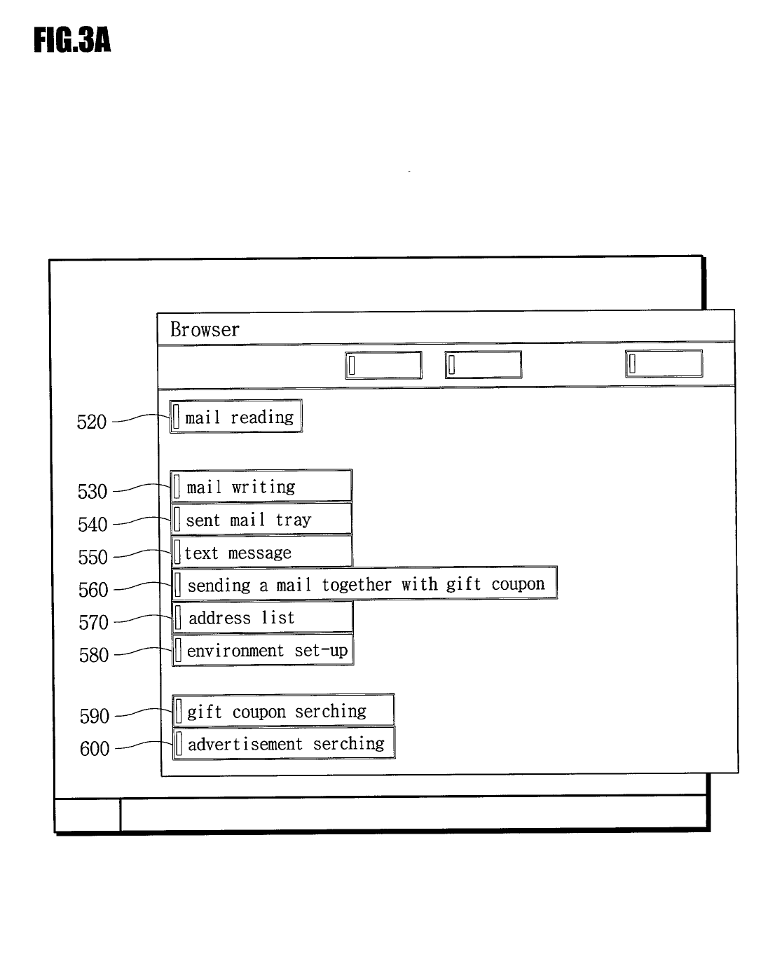

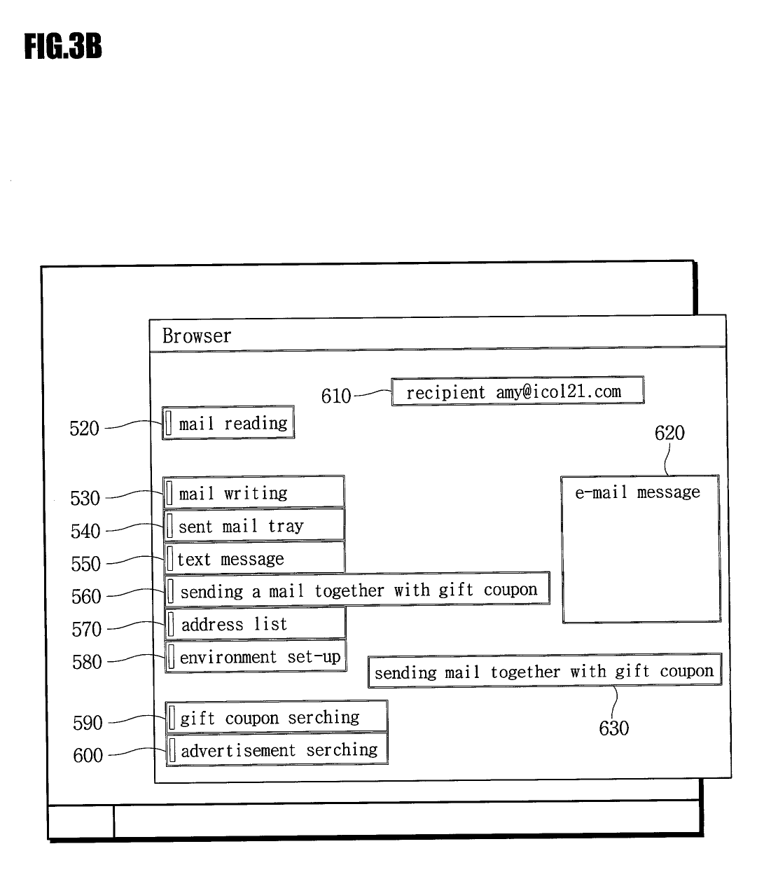

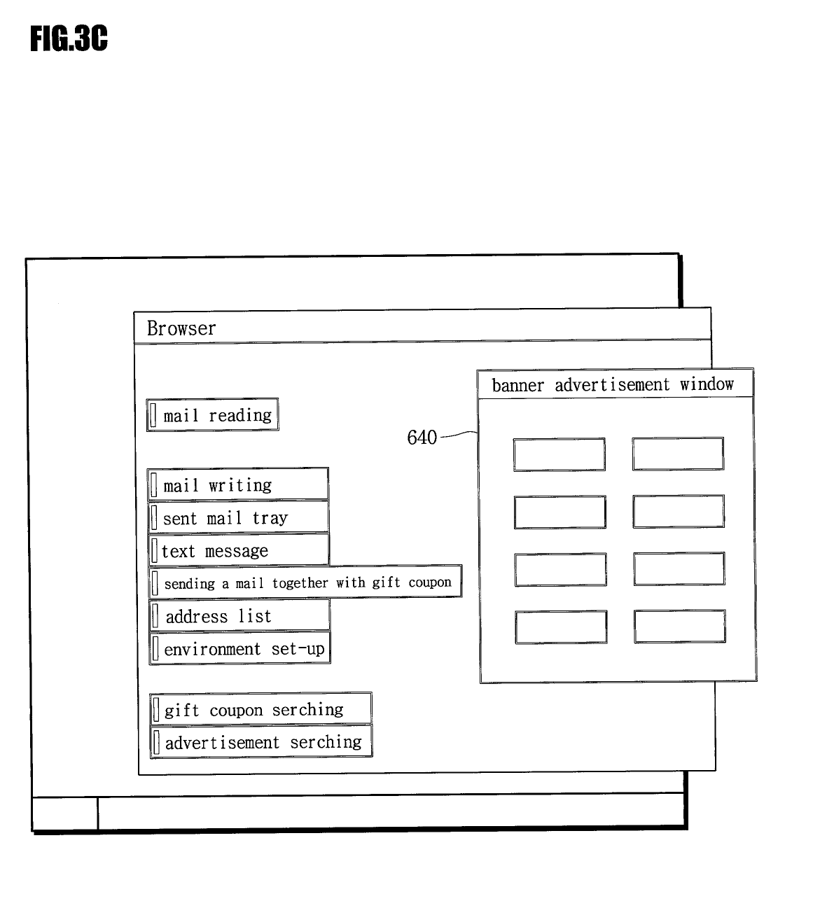

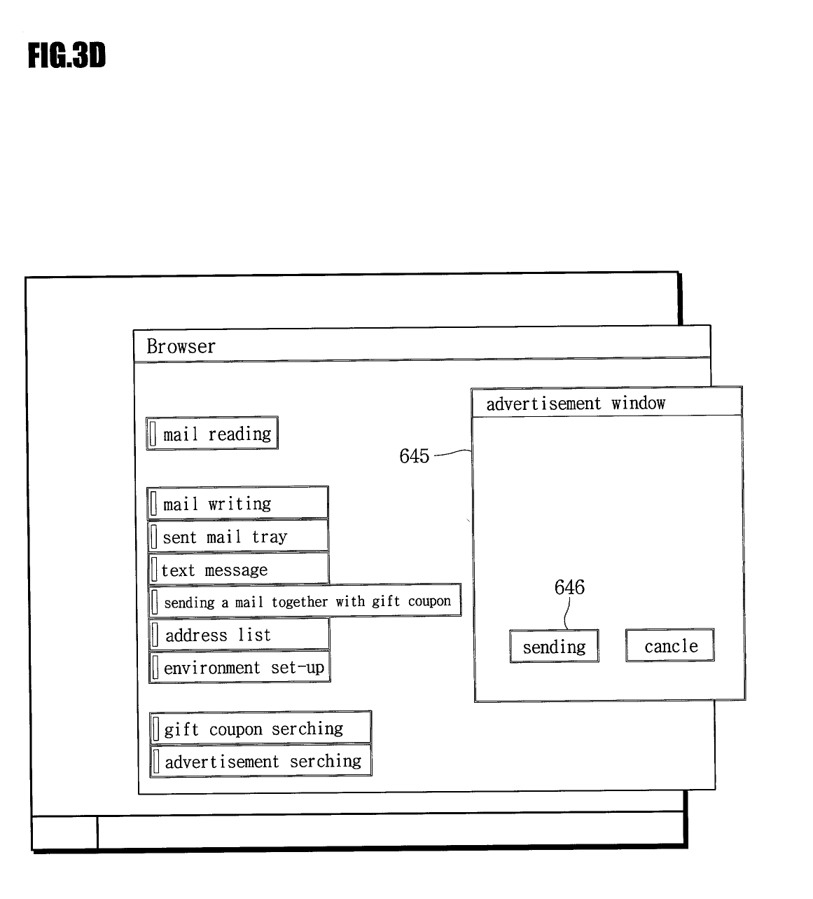

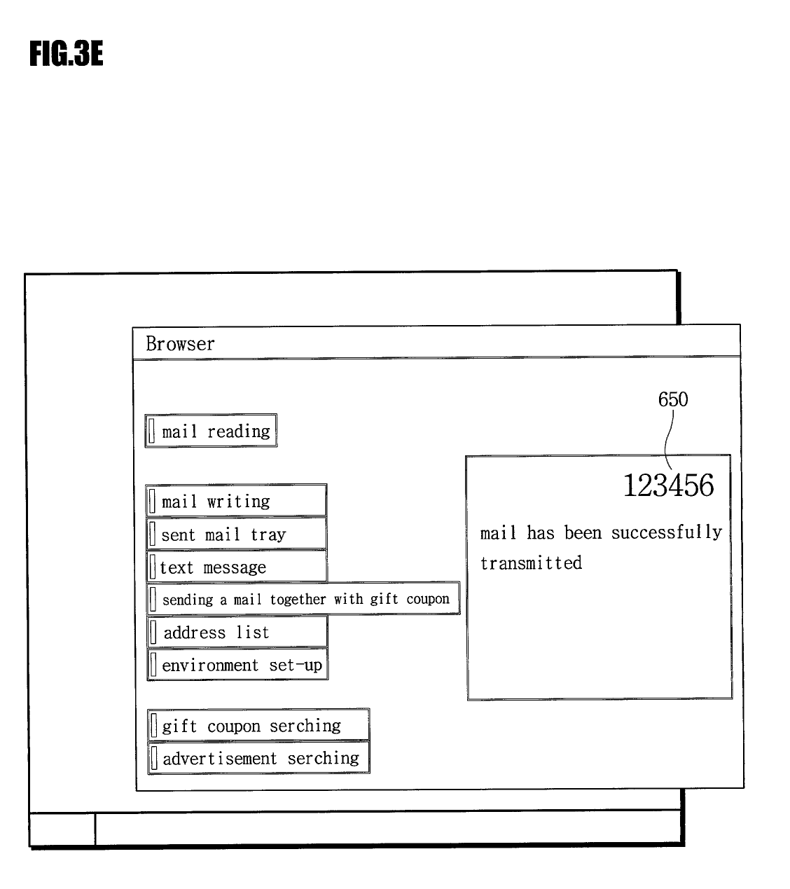

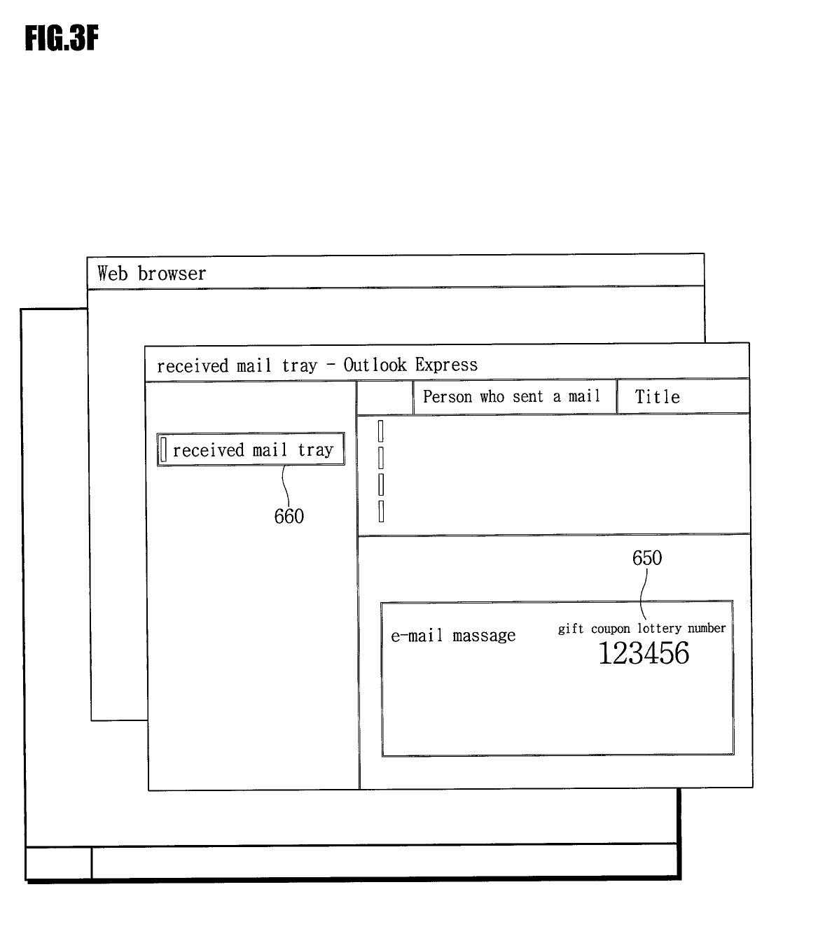

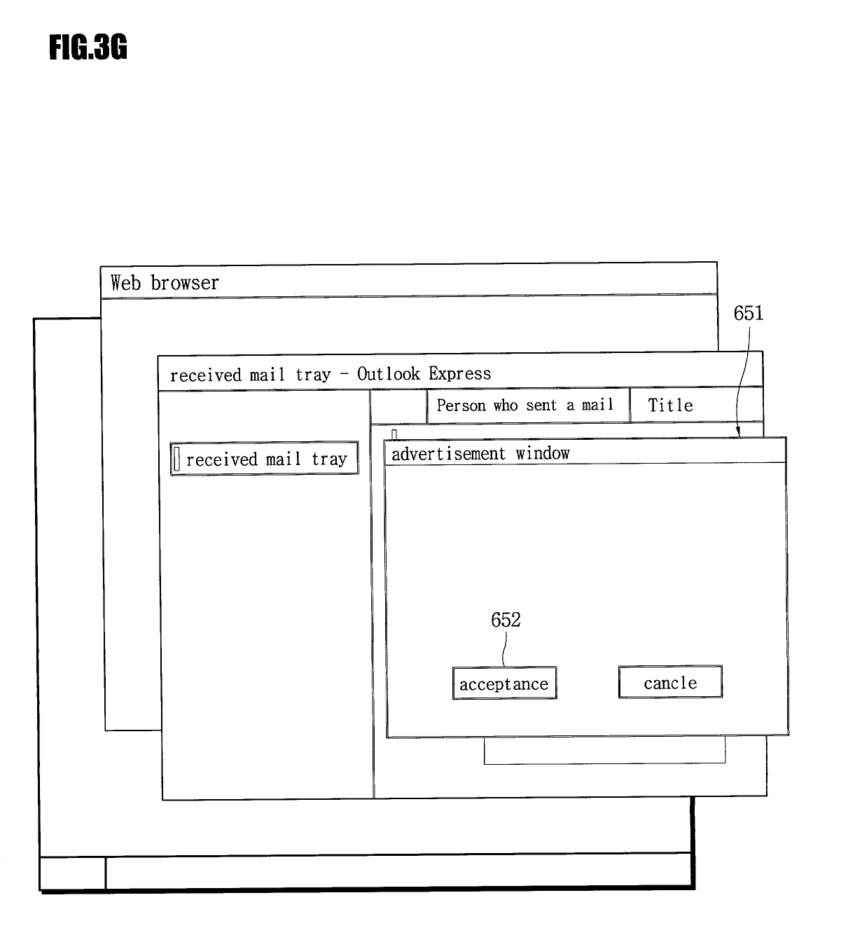

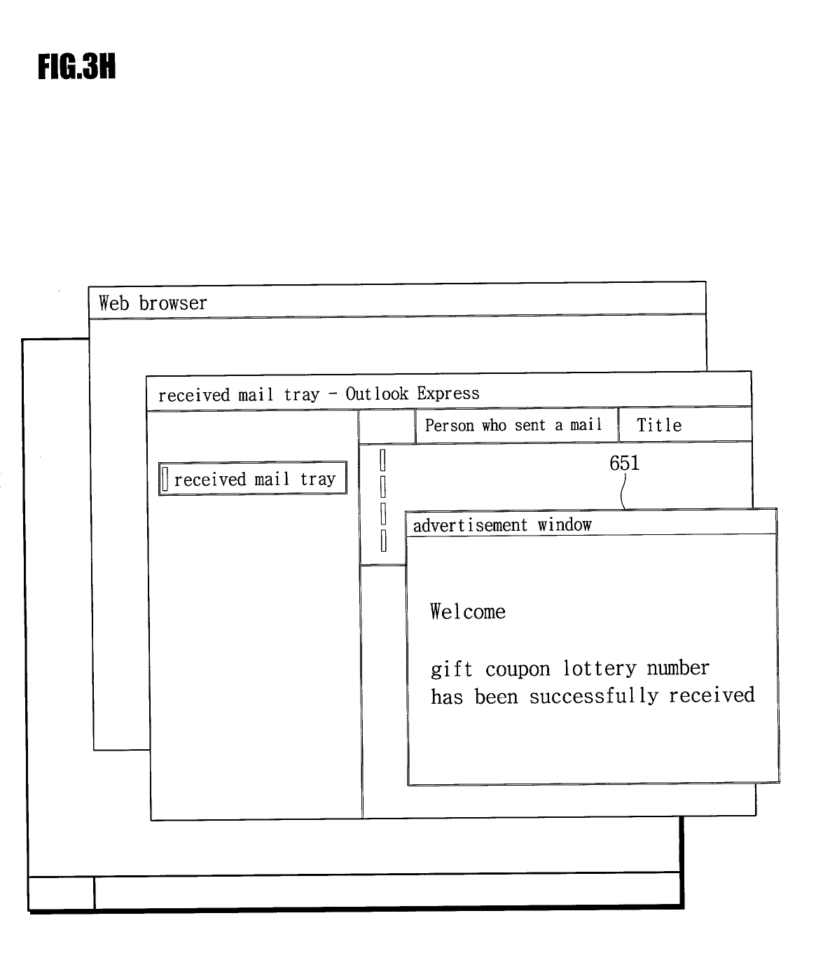

FIG. 3A through 3H are exemplary views showing the processes of a method for transmitting a gift coupon-enclosed electronic mail displayed on a Web browser of a user in accordance with a second modification of the second embodiment of the present invention.

This embodiment is featured in that at the time point when a sender of an e-mail encloses a gift coupon in an e-mail, the sender may select one of a plurality of gift advertisement menus.

Referring to FIG. 3A, an e-mail service provided when an Internet user is connected to a Web server which offers an e-mail service includes menus such as mail reading 520, mail writing 530, sent mail tray 540, a text message 550, sending a mail together with a gift coupon 560, an address list 570 or an environment set-up 580. In addition, the e-mail service in accordance with the present invention may include menus of gift coupon searching 590 and advertisement searching 600.

Referring to FIG. 3B, the user selects the mail writing menu 530, assigns an address 610 of a recipient and transmits an e-mail message 620 as written. At this time, the e-mail sender may enclose a gift coupon therein, for which he or she selects a button 630 for sending e-mail together with a gift coupon.

Referring to FIG. 3C, there is shown a gift coupon list page 640 in which a gift coupons are arranged in a banner advertisement form provided in case that the user selects the button 630 for sending e-mail together with a gift coupon.

In the gift coupon list page, the advertisement content of an advertiser providing the gift coupons can be constructed in a banner form. In this respect, in case that the user clicks on one of the plurality of banner advertisements arranged in the gift coupon list page 640, a gift coupon corresponding to the selected banner advertisement is selected with its lottery number given and then the e-mail together with the gift coupon is transmitted to the user.

In order to provide the sender with the gift coupon list page, a gift coupon list should be read from a database. To output a gift banner advertisement to the gift coupon list page, a gift banner URL can be used. In this respect, the gift banner URL may be linked with a gift banner of the gift coupon providing server or with a Web server of a member company.

A gift coupon table consisting of the gift coupon list includes fields of a gift coupon ID, a gift banner URL, a description URL to link a corresponding gift advertisement page and a gift type content. The gift type includes a gift subjected to performing a lottery for gift after a predetermined time elapses and a gift subjected to performing a lottery for gift instantly.

Referring to FIG. 3D, there is shown an advertisement page 645 provided in case that the e-mail sender clicks to select one of the plurality of banner advertisements arranged in the gift list page 640. In this respect, in order to output a detailed content of the advertisement for the gift, the above-mentioned description URL can be used. Also, in order to display a gift type, the gift type content field is referred.

The advertisement method using an e-mail in accordance with the present invention has an advertisement effect by making the sender to read the advertisement. Subsequently, when the e-mail sender clicks on the sending button 646 of the advertisement page 645 corresponding to the selected gift coupon, the e-mail massage together with the gift coupon is transmitted to the recipient.

At this time, the fact that the sender has sent the gift coupon to the recipient is put on record in the database, and an ID is received to identify the transmission information. The transmission information ID of the present invention is automatically maintained as an ascending or a descending order by virtue of the database.

The transmission information table of the present invention includes fields of a transmission information ID, a member company identifier, an e-mail address of a recipient, an e-mail address of a sender, a gift ID (an external key), a gift acknowledgement, and information of acceptance or denial.

Preferably, in case that the sender transmits an e-mail in an HTML type, the following form is attached to the lower portion of the page to be transmitted.

This portion is a link that the user can check what kind of gift has been reached when the user using a Web mail interface receives the e-mail. Through this link, the recipient using the Web mail interface can check transmission of a gift to him or her and receive it.

<a href=“http://gift confirmation server address/cgi-bin/gift confirmation program.cgi?id=transmitted information ID” target=“_new”>

<“img src”=//address of server putting a banner advertisement/banner.gif>

</a>

At this time, the gift confirmation server address may be an address of the gift coupon providing server or not. That is, in case that the advertiser company, that is, a member company, handles management of gifts by itself, the gift confirmation server address is the address of the server of the member company, while, in case that the advertiser company entrusts the gift coupon providing server with the gift management, the gift confirmation server address is an address of the gift coupon providing server.

In addition, the address of a server putting a banner advertisement in accordance with the present invention may be a gift coupon providing server or not. That is, in case that the gift coupon providing server is entrusted with the gift management, the server managing the banner advertisement is a gift coupon providing server.

Referring to FIG. 3E, there is shown a step of assigning a lottery number 650 to the selected gift coupon and transmitting an e-mail enclosing the gift coupon.

Referring to FIG. 3F, the recipient is connected to a Web server 500 and opens a reception tray of a mail box 660 to check an e-mail transmitted to him or her. At this time, when the gift coupon enclosed e-mail in accordance with the present invention is received, the recipient receives the e-mail message 620 along with the gift coupon lottery number 650.

Referring to FIG. 3G, there is shown an advertisement page 651 provided in case that the e-mail recipient clicks on the gift coupon lottery number 650. Preferably, the recipient selects the acceptance button 652.

Referring to FIG. 3H, in case that the recipient selects the gift coupon receipt acceptance button 652, a message of “A gift coupon lottery number has been received” is displayed at the advertisement page 651 on the screen of the terminal of the user, or a member subscription form page is displayed at a site of the corresponding advertiser or at a gift coupon transmission site.

Then, the gift coupon providing server may inform the recipient of his or her drawing of a winning number for the gift instantly, or later by holding a lottery at a predetermined date in case that the gift requires a period of time.

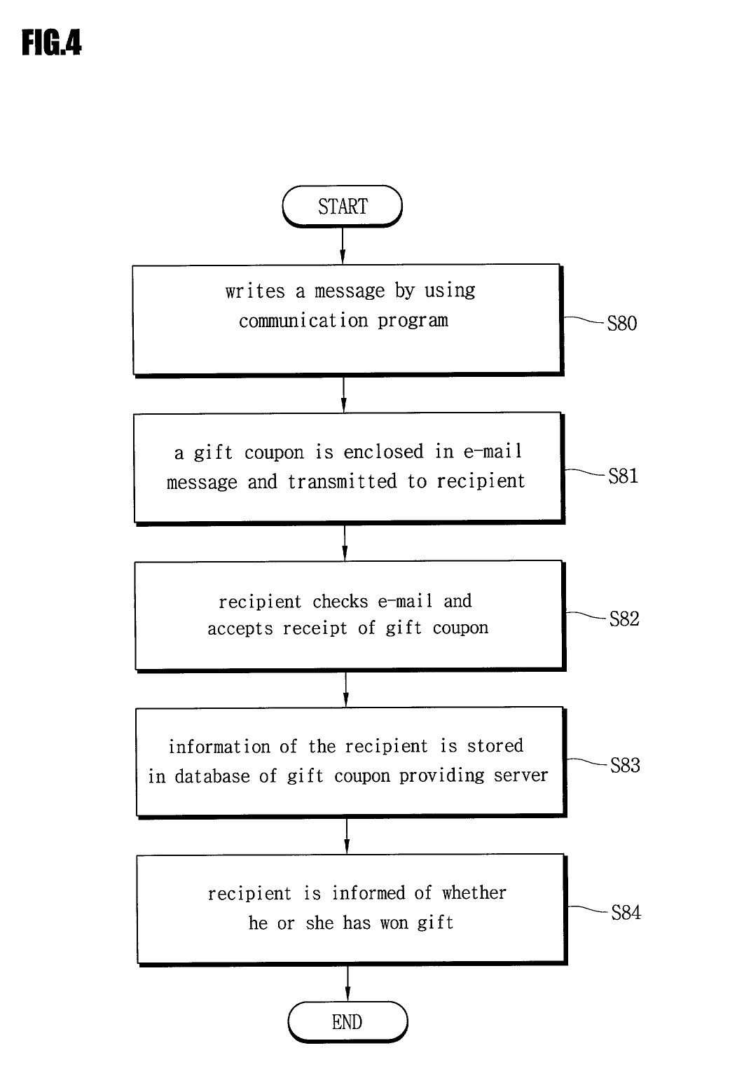

FIG. 4 is a flow chart of processes of a method for transmitting a gift coupon-enclosed electronic mail in accordance with a third embodiment of the present invention.

Unlike the first and the second embodiments in which it is connected to a Web server which offers an e-mail service so that a gift coupon is sent by using the e-mail service offered by the Web server, the third embodiment of the present invention is featured in that a chatting dialog or a real-time message enclosing a gift coupon is transmitted by using a communication program installed in a client computer.

For example, when the user sends an e-mail or a message on a real time basis in a computer terminal in which a communication program such as an Outlook or an instant messenger has been installed, the user encloses an instant gift coupon in the e-mail or in the message and transmits them together.

As for the e-mail service program (i.e., the Outlook or the instant messenger, etc.) employed in the third embodiment as illustrated in FIG. 4, a software block having a gift coupon enclosing function is plugged in the program for use.

Referring to FIG. 4, the sender of an e-mail writes a real-time message or an e-mail message through a communication program installed in his or her own computer terminal (S80). And then, the sender transmits the written e-mail message with a gift coupon enclosed to a recipient (S81).

When the recipient checks the e-mail and accepts receipt of the gift coupon (S82), information of the recipient is stored in the database of the gift coupon providing server (S83) and the gift coupon providing server informs the recipient of whether he or she draws a winning number for a gift (S84).

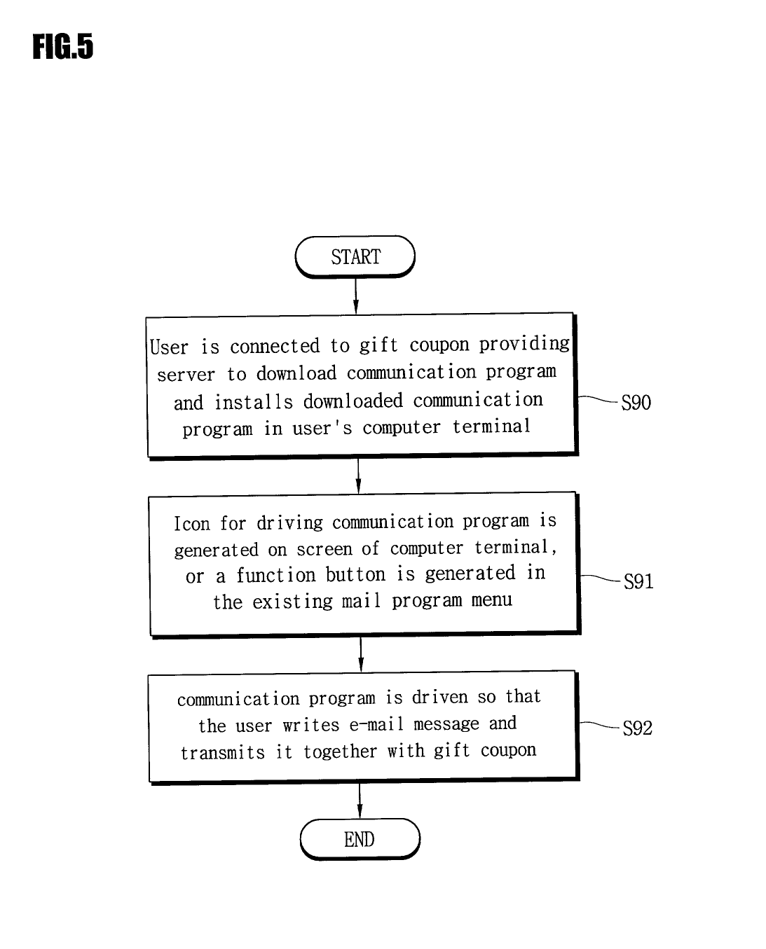

FIG. 5 is a flow chart of processes of a method for transmitting a gift coupon-enclosed electronic mail in accordance with a modification of the third embodiment of the present invention.

The modification relates to a technique to download a communication program of the third embodiment from a gift coupon providing server for use, in which a gift coupon list page can be periodically updated with respect to the gift coupon providing server.

Referring to FIG. 5, the user is connected to the gift coupon providing server to download a communication program and installs it in his or her own computer terminal (S90).

Then, an icon is generated at a screen of the computer terminal for the application program installed in the user terminal so that when the user clicks on the icon, the communication program is operated, or a function button is added to perform a special function related to the gift coupon in the menus of the user's e-mail program (S91).

Subsequently, the user drives the downloaded communication program to write an e-mail message, encloses a gift coupon in the e-mail message and transmits it (S92). The other procedures are the same as those of the third embodiment of FIG. 4.

The gift coupon list page or the gift banner advertisement provided by the gift coupon providing server 200 can be updated on the real time basis through a network.

As so far described, according to the system for an electronic mail enclosing a gift coupon and its transmitting method of the present invention, an advertisement content can be effectively transmitted to the Internet users, for which the Internet users can favorably and voluntarily click on the banner advertisement so that they can receive the advertisement content as well as being provided with an Internet service, and at the same time, a maximized advertisement effect can be made for the advertisers.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An electronic mail transmitting method in which an information providing server provides users with information through an electronic mail on the Internet, comprising the steps of:
transmitting an electronic mail containing information plus a gift coupon given a lottery number from the information providing server to the user;
checking the electronic mail and accepting receipt of the gift coupon on a user's terminal;
storing the information of the user who has accepted receipt of the gift coupon in a database of a gift coupon providing server; and
informing the user of whether he or she has won a gift.

2. The method of claim 1, wherein said checking the electronic mail and accepting receipt of the gift coupon on a user's computer comprises outputting an advertisement page linked relevant to the gift coupon on a screen of the user's terminal.

3. An electronic mail transmitting method in which an information providing server provides users with information through an electronic mail on the Internet, comprising the steps of:
adding a gift coupon list page together with a lottery number to an e-mail containing information and transmitting them from the information providing server to the user;
reading the gift coupon list page after receiving the e-mail and selecting his or her desired gift on a user's terminal;
outputting an advertisement page linked to the gift coupon selected by the user on the screen of the user's terminal;
storing information of the user in a database of the gift coupon providing server when the user accepts receipt of the gift coupon; and
informing the user of whether he or she has won a gift.

4. An electronic mail transmitting method comprising:
connecting with a Web server which offers an electronic mail service and writing an e-mail message;
transmitting the e-mail enclosing a gift coupon given a lottery number from a sender who has written the e-mail message to a recipient;
checking the e-mail and accepting receipt of the gift coupon on a recipient's terminal;
storing information of the recipient who accepted receipt of the gift coupon in a database of a gift coupon providing server; and
informing the recipient of whether he or she has won a gift.

5. The method of claim 4, wherein said transmitting the e-mail enclosing a gift coupon given a lottery number from a sender who has written the e-mail message to a recipient comprising the steps of:
outputting a gift coupon list page containing banner advertisements with various gift menus on the screen of the sender's terminal in case that the sender selects the button for sending the e-mail together with the gift coupon; and
outputting an advertisement document corresponding to the banner advertisement on the screen of the sender's terminal when the sender selects one of the banner advertisements arranged in the gift coupon list page.

6. The method of claim 4, wherein said checking the e-mail and accepting receipt of the gift coupon on a recipient's terminal comprises outputting an advertisement page linked relevant to the gift coupon on the screen of the recipient's terminal.

7. An electronic mail transmitting method comprising:
connecting with a Web server which offers an electronic mail service and writing an e-mail message;
transmitting the e-mail enclosing a gift coupon list page containing banner advertisements with various gift menus each having lottery number from a sender who has written the e-mail message to a recipient;
reading the gift coupon list page and selecting his or her desired gift on the recipient's terminal;
outputting an advertisement page linked to the gift selected by the recipient on the screen of the recipient's terminal;
storing information of the recipient in a database of the gift coupon providing server when the recipient accepts receipt of the gift coupon; and
informing the recipient of whether he or she has won a gift.

8. A method for transmitting an e-mail by using a communication program installed in a user's computer, comprising the steps of:
driving the communication program installed in his or her own computer terminal and writing an e-mail message;
transmitting the e-mail enclosing a gift coupon given a lottery number from a sender to a recipient;
checking the e-mail and accepting receipt of the gift coupon on the recipient's terminal; and
informing the recipient of whether he or she has won a gift.

9. The method of claim 8, wherein the communication program is downloaded from a gift coupon providing server which provides a gift coupon and installed in the user's computer.

10. An Internet e-mail system comprising:
a client computer;
an information providing server for enclosing a gift coupon given a lottery number in an e-mail containing specific information and transmitting it to the client computer; and
a gift coupon providing server for providing an advertisement page corresponding to the gift coupon to a recipient and informing the recipient of whether he or she has won a gift, in case that the recipient accepts receipt of the gift coupon upon receipt of the e-mail,
wherein the client computer, the information providing server and the gift coupon providing server are connected through the Internet.

11. An Internet e-mail system comprising:
a plurality of client computers used by an sender of an e-mail and its recipient;
a Web server for offering an e-mail service so that the sender of an e-mail can transmits his or her e-mail together with a gift coupon given a lottery number to the recipient's computer; and
a gift coupon providing server for providing an advertisement page corresponding to the gift coupon to a recipient and informing the recipient of whether he or she has won a gift, in case that the recipient accepts receipt of the gift coupon upon receipt of the e-mail,
wherein the plurality of client computers, the Web server and the gift coupon providing server are connected through the Internet.
